(19) United States
(12) Patent Application Publication
(10) Pub. No.: US 2005/0182736 A1
(43) Pub. Date: Aug. 18, 2005

(54) Method and apparatus for determining contract attributes based on language patterns

(76) Inventor: Maria Guadalupe Castellanos, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/781,607

(22) Filed: Feb. 18, 2004

(51) Int. Cl. G06F 17/60

(52) U.S. Cl. 705/80

(57) ABSTRACT

A method, system, and apparatus are disclosed for categorizing content of contracts. In one arrangement, a processor-based method for categorizing content of contracts involves determining at, least one language pattern indicative of a contract attribute from text from a plurality of contracts. It is determined whether the language pattern is present in a contract. In response to the presence of the language pattern in the contract, at least a portion of the contract is assigned to at least one contract attribute.

### FIELD OF THE INVENTION

The present disclosure relates to determining contract attributes based on language patterns.

### BACKGROUND

Fewer documents are more representative of an enterprise's relations and commitments than are contracts executed by the enterprise. Contracts define the scope of obligations and benefits with regards to external and internal entities. When an enterprise has a large number of contracts in force, the contracts may become an important factor in making business decisions. Future business plans of an enterprise may be furthered or limited by the commitments expressed in numerous contractual agreements. Similarly, an enterprise must be able to respond to events that might be affect existing contractual relationships.

Many enterprises do not have the capability to easily manage the life cycle of enterprise contracts. The contracts do not always have great visibility to the decision makers, and some decisions may have to be later modified or abandoned when contractual entanglements are discovered.

The content of contracts may range from simple to complex. Contracts may be drafted as combinations of custom and boilerplate language, and the contracts may be subject to multiple legal interpretations. In some situations, contracts may be drafted as complex hierarchical documents that incorporate the contents of other contracts or documents by reference. In this environment, the speed of management decision making may be significantly hampered by the need for manual legal analysis of contracts.

### SUMMARY

A method, system, and apparatus are disclosed for categorizing the content of contracts. In one embodiment, a processor-based method for categorizing content of contracts involves determining at least one language pattern indicative of a contract attribute from text from a plurality of contracts. It is determined whether the language pattern is present in a contract. In response to the presence of the language pattern in the contract, at least a portion of the contract is assigned to at least one contract attribute.

### BRIEF DESCRIPTION OF THE DRAWINGS

FIG. 1 illustrates a system for providing contract data mining according to various embodiments of the present invention;

FIG. 2 illustrates a procedure for contract data mining according to various embodiments of the present invention;

FIG. 3 illustrates a procedure for generating rules from contracts according to various embodiments of the present invention; and

FIG. 4 illustrates a computing arrangement for contract data mining according to various embodiments of the present invention.

### DETAILED DESCRIPTION

In the following description of various embodiments, reference is made to the accompanying drawings which form a part hereof, and in which is shown by way of illustration various example manners by which the invention may be practiced. It is to be understood that other embodiments may be utilized, as structural and operational changes may be made without departing from the scope of the present invention.

In general, the present disclosure relates to text mining techniques used to analyze the content of legacy contracts and extract useful information about the contracts. The information extracted may be organized in a machine-accessible format. The organized information may be used to determine whether and how business decisions might be impacted by the contracts.

It will be appreciated that the term “contract” generally describes a written document that formalizes an agreement between two or more parties. However, documents that are not strictly contractual agreements, but that may be used peripherally to define or enhance an agreement, may be considered “contracts” or “contractual documents” as these terms are used in the present disclosure. Such peripheral documents may include technical specifications, definitional documents, property conveyances, licenses, court documents, government forms and submissions, etc.

The increased awareness of the importance of contracts has not gone unnoticed in the IT industry. Many Enterprise Resource Planning (ERP) and Customer Relations Management (CRM) vendors have offered products that include some knowledge based contract management functionality for organization and access of contracts. Specialist suppliers of contract management products have also emerged, providing tools for performing other aspects of contract management, including content management, office automation, workflow management, and legal perspectives.

However, the contract management solutions discussed above are typically only efficiently used when applied to new business contracts and dealings. These solutions may not provide for management of existing legacy contracts. Some business contracts may be in effect for decades, and may only be accessible as paper copies. Although these contracts could be manually accessed, analyzed, and entered into a contract management system, such a task would be difficult, expensive, and prone to errors.

Contracts stored in a contract management system are typically integrated into a knowledge base that provides insights into the relations and effects of the contracts. This knowledge base may be used to answer questions that may affect a business. For many situations, a contracts management knowledge system may highlight changes that will affect costs. The knowledge system may be used to analyze other situations that may affect existing contracts, including foreign currency fluctuations, corporate bankruptcies and acquisitions, changes in the law, supplier price increases, government legislation affecting business dealings, changes to the tax code, lawsuits initiated against a company, etc. The contract management knowledge system may also contain rules associated with various contracts, including pricing agreements, automatic renewals, etc.

The benefits provided by these contracts management knowledge systems may be apparent to the users of the systems and others skilled in the art. However, what may not be apparent is that the knowledge contained in those systems may also be useful to automatically produce useful facts regarding contracts that are not in the system, such as legacy contracts. Generally, legacy contracts refer to contractually related documents that precede and/or exist outside of a contracts management system. Legacy contracts may be assumed to be un-annotated.

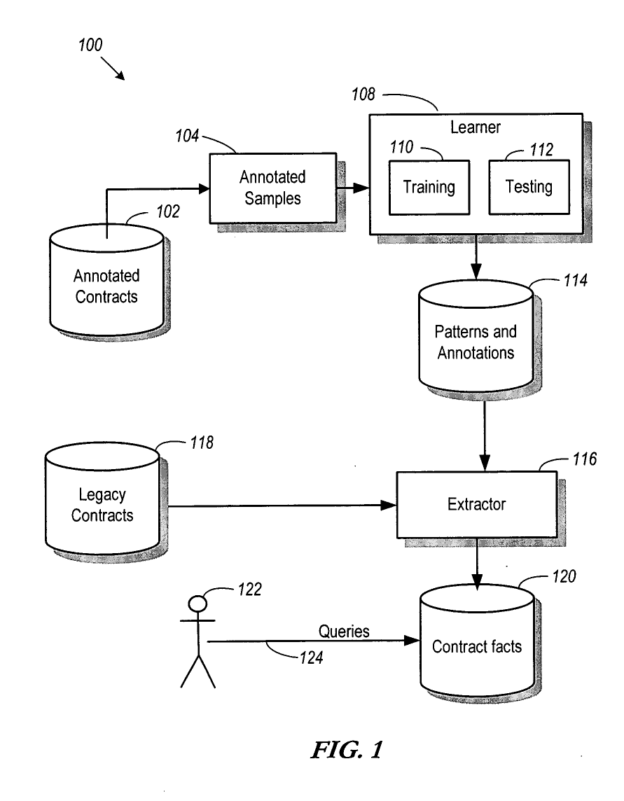

In reference now to FIG. 1, a system 100 is illustrated for providing a knowledge base associated with legacy contracts according to embodiments of the present invention. An annotated contracts database 102 is used to provide annotated samples 104, such as annotated contracts and related annotated documents. The annotated contracts database 102 may exist as part of a contracts management system, or may exist as an unstructured collection of annotated documents.

As used herein, the term “annotated” and “annotations” refers to any machine-readable data or metadata used to ascribe meaning to a document. In one example, the annotations may include eXtensible Markup Language (XML) tags. The XML tags may be included as part of the contractual document, and may exist as a separate data model that provides definition and structure to associated contracts. The power of using annotations such as XML to structure a document and to tag its content with meaningful labels provides the ability to clearly identify pieces of information used to define policies and the processes by which the contracts are enforced. These policies and processes may be integrated with other business software for various planning functions. However, the annotations also have another purpose: that of providing examples on which to train learning models to recognize specific pieces of information. These examples are manually annotated. Once models to recognize these pieces of information have been learned, they are used to automatically annotate the rests of the contracts.

Although XML tags are a commonly used form of document annotation, it will be appreciated that other identifiable data within the contract language itself may also be used as annotations. For example, paragraph titles and definitional clauses may be used as annotations, especially if such data is used consistently and is parsable by the document management system.

The present disclosure describes applying information extraction technologies to contract-management knowledge. Information extraction systems require a separate set of rules for each domain, whether extracting from structured, semi-structured or free text. This makes machine learning an attractive option for knowledge acquisition.

In general, the annotated samples 104 include contractual language and annotations describing the contractual language. A learning arrangement 108 may use the contract language and annotations as input to a training element 110 and/or a testing element 112. The learning arrangement 108 may be used to programmatically build a knowledge base that links the annotations to various patterns found in the annotated samples 104.

The training element 110 is generally used to sift through data and determine important relations within that data. In this case, the functions provided by the training element 110 may include identifying patterns within the documents and determining whether the existence of a particular pattern is indicative of an annotation associated with that pattern.

The knowledge produced by the training and testing elements 110, 112 may be placed in a rules database 114. This database 114 may be any form of data storage element suitable for storing the information such as rules linking syntactical patterns with annotations that are extracted by the learning arrangement 108.

The rules database 114 may be accessed by an extractor element 116. The extractor element 116 may apply the knowledge stored in the rules database 114 to legacy contracts. The legacy contracts may be accessed via a legacy contracts database 118. The legacy contracts database 118 may include any form of data storage, including a relational database or a filesystem. The legacy contracts are converted to a machine readable format before being placed in the database 118. This conversion may involve converting electronic documents into a standard data format and/or converting paper documents to an electronic format using Optical Character Recognition (OCR) or similar technologies.

The extractor element 116 may access legacy documents in the legacy contracts database 118 and rules in the rules database 114 to identify language patterns of the rules in the legacy documents. The patterns may be used by the extractor element 116 to identify which annotations to potentially associate with the corresponding portions (i.e. values) of the legacy documents. The extractor element 116 may use one or more statistical analyses to choose the most likely annotations to associate with parts of the legacy documents.

The associations between annotations and values in the legacy documents created by the extractor element 116 may be stored as data in a contract facts database 120. The contracts facts database 120 may be accessed by users 122 for purposes of running queries 124. The users 122 may run queries 124 to determine current facts (e.g., structure of various business relationships) and/or to predict effects of actual or theoretical events.

It is a common practice for companies to have a set of free text templates for different kinds of contracts. The regularities found in each kind of template make this domain suitable for applying machine learning techniques to extract values of interest from contracts based on patterns learned from the annotated sample contracts. For example, it may be desirable to extract information concerning the term of contracts.

Recent research with a capital intensive enterprise revealed that more than 60 percent of active service contracts had been extended by default, and that nearly half of these were in their second extension. Many of these contracts provided for price uplifts in line with an agreed inflation index, meaning that suppliers had been able to increase prices steadily without the appropriate level of review from the buying organization. Contract templates include a term clause with valuable information that, when extracted, gives the opportunity for a better management of contract extensions.

To illustrate, Listings 1 and 2 show example long-term (LTA) and corporate purchase (CPA) agreement term clause templates, respectively. In general, LTA, CPA, and similar purchase contracts may follow similar templates. Therefore, such contracts will often share the regularities in the context (e.g., surrounding words and syntactic relations between surrounding words) of the attributes/variables of interest (e.g., the attribute “start date”). Likewise, for other kinds of contracts with different format and wording, other regularities exist for similarly associated attributes. An automated system may be able to learn the different lexical and syntactic patterns that exist for each attribute so that their values can be extracted from all the existing contracts.

Listing 1

LTA: This LTA shall be a rolling [##] year Agreement for the period
[START DATE] to [EXPIRATION DATE] inclusive, with annual
extensions beyond [EXPIRATION DATE] if mutually agreed to by Buyer
and Seller. Both parties agree to meet prior to [MM/DD/YY] to consider
an extension for [##] year(s) . In like manner, both parties shall meet prior
to [MONTH/DAY OF EXPIRATION DATE] of each year to consider
future extensions.

Listing 2

CPA: This CPA will be a [TERM] Agreement for the period [START
DATE] to [EXPIRATION DATE] inclusive. Both parties agree to meet
prior to [MM/DD/YY] to consider an extension of [##] year(s). In like
manner, both parties shall meet prior to [MONTH/DAY OF
EXPIRATION DATE] of each year to consider future extensions.

Besides the templates illustrated in Listings 1 and 2, additional contextual data models may be defined to organize and categorize the components of the contracts. These data models will be referred to herein as document object models (DOM) and component object models (COM). The DOM is a model of the structural components of contracts of a given kind, (e.g., sections and clauses). The structural components define a context that may be described by subject headings and sub-headings of contract sections. For example, a given kind of contract may have a section named Shipment and Delivery which in turn has the clauses Prospective Failure, Untimely Shipment and others. An example XML-formatted DOM is shown in Listing 3. Notice that the element term, might correspond to the term clause in Listing 1.

Listing 3

<DOM>

<id> 0008 </id>
<contract>

<type>

LTA

</type>

...
<section>

<name> Shipment and Delivery </name>
<clause> Prospective Failure </clause>
<clause> Untimely Shipment </clause>

...

</section>
<section>

<name> term </name>
<clause> term </clause>

</section>
...

</contract>

</DOM>

In addition to the DOM, a contract object model (COM) may be defined for a contract template. The COM specifies the relevant attributes of contracts from which values are to be extracted. For example, attributes such as the expiration date of a contract or the transportation means in case of untimely shipment may be appropriately included in a COM. A simple XML COM for the relevant attributes (i.e., pieces of information) of the LTA term clause in Listing 1 is shown in Listing 4.

Listing 4

<COM>

<id> 235 </id>
<contract>

<type>

LTA

</type>

<attribute>

<name> expiration_date </name>
<datatype> date </datatype> /optional
<nature> mandatory </nature>

</attribute>
<attribute>

<name> untimely_transportation_means

</name>

<datatype> transportation </datatype>
<nature> mandatory </nature>

</attribute>
...

</contract >

</COM>

The “datatype” tags in the COM may define primitive types such as int or String, but they may also define semantic classes that may be used to make the search for rules more efficient. In one application, semantic classes may enumerate the possible values of an attribute of that datatype. For example, the datatype transportation could be defined as shown in Listing 4A.

Listing 4A

<datatype> transportation

<kind> enumeration</kind>
<values> airplane, ship, truck, trailer
</values>

</datatype>.

In the absence of this semantic class, the type for attribute untimely_transportation_means could simply be the primitive datatype String. Alternatively, the “datatype” could specify the possible formats that an attribute of that type can adopt. For example, the datatype date could be defined as shown in Listing 5.

Listing 5

<datatype> date

<kind> format </kind>
<values> mm/dd/yy, month dd year, mm-dd-yyyy
</values>

</datatype>.

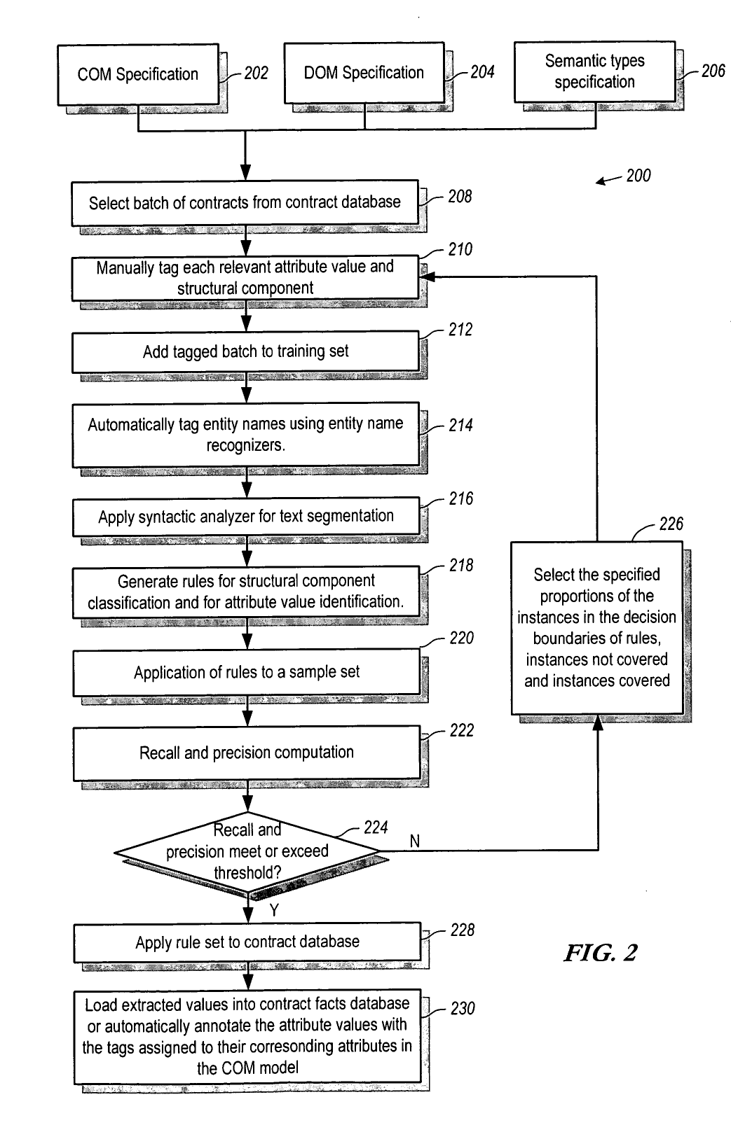

Once models such as DOM and COM have been defined for the contract templates, the models may be used as a specification to manually annotate a representative subset of contracts from the collection of contracts in order to cover as many of the different patterns existing for each attribute as possible. In reference now to FIG. 2, a flowchart 200 illustrates aspects of information extraction according to embodiments of the present invention. The procedure 200 begins with COM 202, DOM 204, semantic type 206 specifications provided as inputs that cover the contracts database of interest. Each contract from the sample (i.e., annotated) batch is selected (208) from the database for pattern analysis.

As in any supervised machine learning, there may be some manual effort required to provide annotations. Adding annotations is also referred to as tagging or labeling (210). The manually annotated contracts are added (212) to a training set. The training set may be composed of sample contracts whose values to extract (corresponding to the relevant attributes specified in the appropriate COM) are tagged with the corresponding name of the attribute, so that machine learning algorithms can be trained on this set to recognize the values for those attributes. Listing 6 shows an annotated example that is an instantiation of the term clause of the CPA template of Listing 2, with the relevant values manually tagged.

Listing 6

This CPA will be a <TERM> one year </TERM> Agreement for the
period <START_DATE> 05/01/03 </START_DATE> to
<EXPIRATION_DATE> 05/01/04 </EXPIRATION_DATE>
inclusive. Both parties agree to meet prior to <IMMEDIATE_EXTEN-
SION_MEET_DATE> 04/01/04 </IMMEDIATE_EXTENSION_{—}
MEET_DATE> to consider an extension of <EXTENSION_PERIOD>
one </EXTENSION_PERIOD> year(s). In like manner, both parties shall
meet prior to <FUTURE_EXTENSION_MEET_DATE> 05/01
</FUTURE_EXTENSION_MEET_DATE> of each year to consider
future extensions.

The tagging task (210) can be facilitated by using a graphical user interface (GUI). With a GUI, the text of the contract to label may be displayed on the main frame of the screen along with the COM model corresponding to that kind of contract on a side frame. The user simply highlights the piece of information to extract and then drags it to the corresponding component object in the COM model. The system then automatically adds (212) the appropriate tags associated with that piece of information to the training set, according to the COM specification.

The tagging task (210) includes not only tagging the elements to be extracted, but also the creation of semantic datatypes, when applicable. This last task may be facilitated by automatic tagging (214) of recognizable entries to be used as datatypes in the COM specification, such as names of companies, people, dates and the like. Technologies such as Named Entity Recognition (NER) can be used to recognize names of entities for automatic tagging (214). NER is one technique used in general-purpose Information Extraction (IE) applications. There are a number of named entity recognizers currently available. Once contracts have been tagged, they are added to the training set.

The annotated contracts added to the training set are used to derive rules that associate patterns with the annotated attributes. Once the attributes values have been tagged (210, 214), the text proximate to the tagged attributes may be fragmented into sentences and these sentences in turn may be segmented (216) into syntactical components, such as subject, by applying a syntactic analysis. The segmentation (216) makes possible the identification of contextually significant syntactic patterns that can be used during rule generation (218).

The antecedent of each rule that is generated (218) includes two parts: 1) a name or identifier of the specific structural component (according to the DOM corresponding to the contract type) where the value to extract is encountered, and 2) a regular expression corresponding to a pattern of contextual words or a syntactic pattern augmented with a regular expression of contextual words. The two-part rule can improve accuracy in the application of rules. The consequent of the rule is the attribute name (e.g., a name for that type of information piece).

For example, a rule for identifying a start date of a term would include a regular expression for identifying a date and a structural component corresponding to a “term” clause. A long contract may include many dates, so applying only the regular expression to the entire contract is more likely to produce errors, i.e. identifying dates (start dates or otherwise) that are not related to the contract term. Pairing the structural component with the regular expression allows restricting the use of the regular expression to only those portions of the contract associated with the structural component. Therefore, when the regular expression is limited to just the appropriate structural component (the “term” clause), the resulting matches are more likely to be an actual term start date.

The structural components of the rules have a significant impact in the efficiency of the process both at rule generation (218) time as well as at rule application time. Rules learned have to be valid only in the context of the structural component where the attribute to extract exists, and not in the context of the whole document. Otherwise, many good rules might be invalidated by counterexamples from other structural components and consequently rules to be valid in the context of the whole document would have to be found. Also, at rule application time, pattern matching of regular expressions in the rules is confined only to those structural components where those expressions were originally found. Therefore a data model such as DOM is used to partition a document into well identified structural components that limit the generation and application of the rules.

To generate the second part of the rule (the regular expression), a number of different techniques may be used to identify valid expressions. The techniques that suit this domain may be based on machine learning. Examples of such techniques are the top-down induction methods to learn extraction rules from free text. Top-down induction rules have been described in “CRYSTAL: Inducing a Conceptual Dictionary,” Soderland S., et al, Proceedings of the Fourteenth International Joint Conference on Artificial Intelligence (IJCAI-95)(Crystal); and in “Learning Information Extraction Rules for Semi-Structured and Free Text” Soderland S., Machine Learning Journal, vol. 34, 1999 (Whisk). Of course, other algorithms used for the identification of regular expressions may also be used. For illustration purposes the examples herein assume the use of one such top-down induction algorithm.

Any technique used to generate these regular expressions should be supervised (or at least semi-supervised), which means that the algorithm requires a set of contracts with tagged examples, called training set, from which patterns are learned, as previously explained. The tags of the training instances are used to guide the creation of rules and also to test the performance of proposed rules. If a rule is applied successfully to an instance, the instance is considered covered by the rule. If the extracted value exactly matches a tag associated with the instance, it is considered a correct extraction, otherwise as an error (counterexample to the rule) and the rule is invalidated.

Once the rule set covers all the tagged instances in the training set, the rules are applied (220) to a sample set. The extractor 116 (see FIG. 1) applies the rules in the repository 114 to a subset of untagged instances to automatically extract values which then are corrected by the user. The results of this testing on the sample set are used to compute (222) recall and precision of the rules.

Recall and precision are two typical measures of the quality (i.e., accuracy) of the extraction rules. Precision is the proportion of correct extractions from all the extractions done (i.e., measure of correctness). Recall is the proportion of correct extractions from all the extractions that had to be done (i.e. measure of completeness). If the resulting recall and precision do not meet or exceed (224) predetermined thresholds, the process is repeated. The training set is augmented first with instances covered by the rules but incorrectly extracted (i.e., counterexamples that invalidate the rules). Second, the training set is augmented with instances that are in the boundaries of rules, called “near misses” (i.e. instances not covered by any rule but covered by a minimal generalization of a rule). Third, instances not covered by any rule are added to the training set.

Once the recall and precision satisfy the threshold (224), the rules may be applied (228) to the contract database to extract the relevant information from the contracts. At the time the rules are applied (228), the search for matches to the regular expression in a rule is confined to the appropriate parts of the contract. Thence, the structural knowledge of the document, may be used to refine the search. This structural knowledge may be provided using manual or automatic tagging of structural components according to the corresponding DOM.

When a regular expression for extracting the value of an attribute is induced by the top-down algorithm, the structural component where the expression was found can be identified and added as the component element (see Listing 6) of the pattern of the rule. This provides the opportunity to make the process more efficient. As explained before, during the creation and validation of rules, limiting the application of the regular expression to the structural component prevents good rules from being invalidated by possible (but incorrect) matches that may be found in other structural components. Rule generation then becomes faster. By the same token, when rule generation is complete and rules are applied (228) to the contract database 118, expression matching can be narrowed to the structural components specified in the rules, without the need to search in the whole document.

Once rules for the different relevant attributes have been learned on the training set (annotated subset of the existing contracts), the rules are applied (228) to all the other contracts. When the pattern in a rule is matched, the corresponding value is extracted. These attribute values are loaded (230) into a database that stores contracts' facts to be retrieved by ad-hoc queries (for example, list all the contracts that will expire next month) or reporting (for example, a report on the term of all existing contracts) to better control the lifecycle of contracts.

The flowchart 200 illustrates only an example procedure usable for extracting knowledge from contract data. It will be appreciated that the sequence of the steps may be varied, and some steps may be implemented in parallel. Similarly, various additional steps may be used to improve efficiency of the process. For example, to reduce the manual effort of tagging training instances, the tagging process (210) may be interleaved with the learning process. In this case, a GUI may prompt the user with a batch of instances to tag every time it needs more tagged instances to train on. Since it is the learning component that actively identifies the most useful instances to be tagged, this mode of learning is called active learning.

During active learning, the batch of contracts to manually tag is determined by the system. Some of the new instances to tag will be near misses (near the decision boundaries) of the rules generated so far and will help to augment the coverage of the rules by minimally generalizing them. Some other tagged instances may be counterexamples to existing rules, in which case the rule is discarded so that a new rule may be grown. Finally, those instances that are covered by the existing rules will augment the precision of the rules. Once the new batch has been tagged, a new instance-tag pair not covered by any existing rule is selected. This pair becomes a seed to grow a new rule.

As previously discussed, the process of rule generation (218) may include identifying patterns and generating rules associated with the patterns. Rule generation generally has two components: 1) inducing a pattern in the form of a regular expression, and 2) identifying the structural component where that pattern occurs. Listing 7 shows what an example rule might look like.

Listing 7

<Rule>
<id> 153 </id>
<antecedent>

<structural_component>

<section> TERM </section>
<clause> TERM </clause>

</structural_component>
<expression>

‘period’ date ‘to’ (date)

</expression>

</antecedent>
<consequent>

<COM_object> 235 </COM_object> // see listing 4
<attribute> expiration_date </attribute>

</consequent>
</Rule>

The expression in the rule shown in Listing 7 corresponds to one that could be derived from the tagged “expiration_date” instance shown in Listing 6. Words in single quotes are to be matched exactly, words without quotes correspond to predefined primitive or semantic datatypes types (e.g., datatype “date” defined in Listing 5) and words in parenthesis are the information to be extracted.

As mentioned above, one possible implementation of pattern induction involves the use of the top-down induction algorithms Crystal or Whisk. The rule induction is performed top-down, which means that first the most general rule that covers a seed is found, and then the rule is extended by adding terms one at a time in order to generalize the rule to cover more instances.

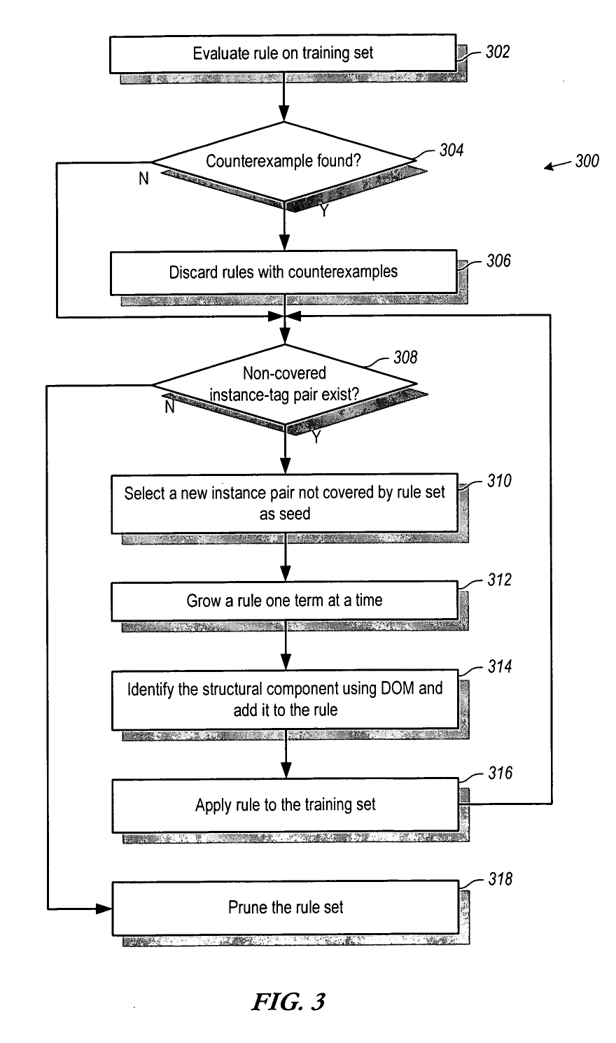

The rule generation process according to embodiments of the present invention is illustrated in the flowchart 300 of FIG. 3. The process involves validating (302) each learned rule on the testing set. If counterexamples (i.e., instances covered by a rule but resulting in error) are found (304), then those rules with counterexamples are discarded (306). If is determined (308) that there are instance-tag pairs of the current attribute being considered not covered by a rule, then one of the instance-tag pairs is selected (310) as a seed for top-down rule induction. The pattern of the rule is “grown” (312) one term at a time according to the pattern induction method. Next, the DOM structural component of the contract associated with the instance is identified (314) and added to the rule. The rule is then applied (316) to the training set. Once all of the tag-instance pairs have been analyzed, the rule set is pruned (318) according to the top-down rule induction method.

The process 300 is iterative, as rules are further refined with new examples. Once a rule cannot be further extended it is saved in the rule repository and a new seed restarts the process until all the tagged values for an attribute are covered by the rule set. Since contracts are made of grammatical text, a syntactic analyzer can be used to take advantage of the clausal structure of sentences and any other relevant information in the text.

However, it will be appreciated there are other alternative techniques which could be utilized for the purpose of defining rules. Moreover, there is the possibility that using a combination of techniques the accuracy of the results could be improved. For example, a voting scheme may be used on the values extracted by different techniques for each relevant attribute of each contract.

As described above, one part of generating rules involves identifying (314) the structural components specified in the DOM. During rule generation and training, it may be assumed that sections of the sample contracts have been manually annotated with the tags corresponding to these structural components.

However, when the rules are applied to data extraction (228) (see FIG. 2), legacy documents have not been annotated with structural components. In order to accurately apply the rules, in particular, the structural component of the antecedent part of a rule, different sections and clauses of these legacy contracts would need to be categorized according to the structural components specified in the DOM of the corresponding contract type. It will be appreciated that automatic structural categorization of unannotated documents could be useful at the time of data extraction (228). The annotated documents used in rule generation and training may contain patterns useful in automatically categorizing portions of unannotated documents. A learning system may be adapted to determine structural categories of contract sections based on text patterns, and these structural determinations can be used in the identification of attribute values in the contract according to the structural components specified in the antecedent part of the extraction rules (see, e.g., Listing 7).

For example, consider the term clause template of an LTA contract in Listing 1. The DOM (see Listing 3) associated with such contract type indicates that a term clause is a relevant structural component of this type of contract and therefore a pattern to identify (i.e., categorize) such a clause needs to be learned. Therefore, the language used in the annotated clauses of the sample contracts such as the clause in Listing 1 provides the elements to learn patterns that are characteristic of such clauses. The training element 110 (see FIG. 1) is trained not only to learn patterns of contract attributes (for example, the termination date) specified in the COM, but also to determine which patterns are indicative of the structural components (i.e., sections and clauses) of a contract type specified in the DOM.

The training element 110 may use many different approaches to determine language patterns within the contract text. In one example, the training element 110 may break the text into word sequences. For example, sequences such as “LTA” and “annual extension” may indicate to a person reading the contract that this may be an LTA term clause. Other patterns besides word sequences may also be examined by the training element 110, such as partial word sequences (e.g., n-grams), special characters (e.g., currency signs), use of capitalization, use of numbers, synonyms, etc.

Even though a person reading the clause might be able to define certain critical patterns that indicate the meaning of an annotated entry, the training element 110 typically has no knowledge of the meanings of the patterns it examines. In the present example, the training element would also have to consider whether sequences such as “Buyer” and Seller” are relevant to an LTA clause.

The process of separating important patterns from superfluous patterns in an annotated document is another function that may be performed by the training element 110. Initially, the training element 110 may assume all patterns are equally valid for the annotations in a single sample document. However, upon compiling patterns across all sample documents, the training element 110 may detect increased statistical probabilities of some patterns for same or similar annotations.

Of course, some patterns detected by the training element 110 may be highly indicative of a particular structural category, even though these patterns appear in only a small amount of the tested samples. Similarly, some patterns may appear in all tested categories (e.g., words such as “the” ) that have no correlation at all to a specific structural component.

The training element 110 may use analytical techniques to identify those patterns that are most likely to occur within a single annotated type, while ignoring those patterns that commonly appear in all annotated types. The training element 110 may compile these results as a database of patterns and associated probabilities. The probabilities may include both a general probability of the existence of a pattern and a conditional probability of a pattern being found within a particular annotation type.

The probabilities and patterns analysis performed by the training element 110 may be used to form a predictive model. One such technique includes a Bayesian analysis. A Bayesian analysis uses an equation known as Bayes' rule to predict the existence of one event given another event. Using the annotation P(Y|X) as the conditional probability of event Y given event X, Bayes' rule may be expressed as P(Y|X)=P(X|Y)P(Y)/P(X).

In the example text of Listing 1, a useful application of Bayes' rule would be to determine the probability of an LTA clause given that the word “extensions” is in the text, or P(LTA|extensions). Applying Bayes' rule, this would be expressed as P(LTA|extensions)=P(extensions|LTA)P(LTA)/P(extensions). Therefore, factors that would increase the probability of P(LTA|dispute) include a low probability of the word “extensions” occur in general, a high probability that LTA clauses occur in general, and a high probability that LTA clauses contain the word “extensions.”

The rules used to determine structural categories may be tested and refined during training procedures shown in FIG. 2. The rule generation (218) step may include a procedure used to generate rules that predict structural categories based on contract text. The effectiveness of these rules can also be tested during recall and precision computation (222).

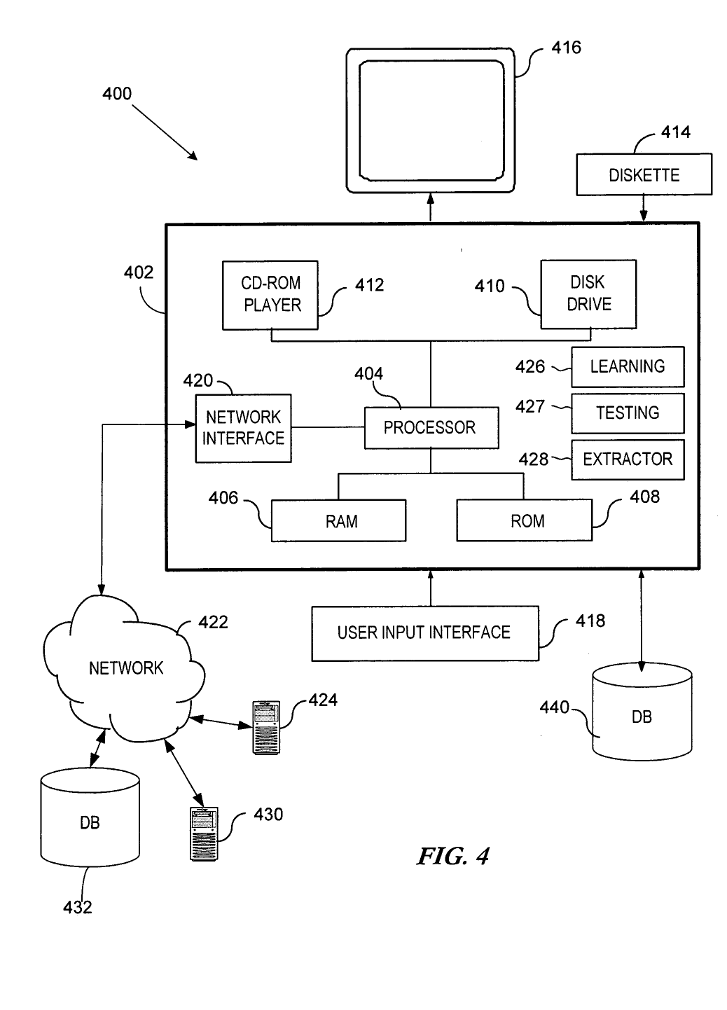

The procedures described herein for analyzing and annotating the legacy contract may be implemented by any manner of data processing arrangement known in the art. FIG. 4 shows a data processing arrangement 400 configured for categorizing legacy contracts according to various embodiments of the present invention. The arrangement 400 includes a computing apparatus 402 with a processor 404 and coupled to some form of data storage. The data storage may include volatile memory such as RAM 406. Other devices that the apparatus 402 may use for data storage and retrieval include a ROM 408, disk drive 410, CD-ROM 412, and diskette 414. A display 416 and user-input interface 418 may be attached to the computing apparatus 402 to allow data input and display. The computing apparatus 402 includes a network interface 420 that allows the apparatus to communicate with other computing devices 424, 430 across a network 422.

In one arrangement, the computing apparatus 402 contains learning 426, testing 427, and extractor 428 modules. The learning module 426 may be used to examine annotated contracts data and determine relevant patterns in the data that may be indicative of structural components (like “Shipment and Delivery”) specified in the DOM and attributes (like “untimely_transportation_means”) specified in the COM. The associations (e.g., rules) between relevant patterns and structural components and attributes may be used by the learning module 426 to form a knowledge base.

The testing module 427 may use a set of annotated test data to verify and refine the knowledge base produced by the learning module 426. The extractor 428 may be used to analyze the legacy contracts, by applying the patterns in the rules of the knowledge base to extract the values of the attributes specified in the COM model of the given type of contract. The extractor 428 may express results of the analysis as annotations in the legacy contracts (e.g., automatic tagging in XML) or simply by extracting the values and inserting them in the contract facts database.

The annotated contracts, legacy contracts, knowledge base, and test data, used by the various modules 426, 427, 428 may be accessible via any combination of a local storage devices (e.g., disk drive 410), a directly connected database 440, and/or a network connected database 432. Computer-executable instructions that perform the functionality of the various modules 426, 427, 428 may be provided as software on any computer-readable medium, such as the diskette 414 or a CD-ROM. The software may also be provided locally or remotely via a data transfer interface such as the network interface 420.

From the description provided herein, those skilled in the art are readily able to combine hardware and/or software created as described with appropriate general purpose or system and/or computer subcomponents embodiments of the invention, and to create a system and/or computer subcomponents for carrying out the method embodiments of the invention. Embodiments of the present invention may be implemented in any combination of hardware and software.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

1. A processor-based method for analyzing contracts, comprising:
determining at least one language pattern indicative of a contract attribute from text of a plurality of contracts;
determining whether the language pattern is present in a contract; and
in response to the presence of the language pattern in the contract, assigning text associated with the language pattern to the contract attribute.

2. The method of claim 1, wherein determining at least one language pattern indicative of the contract attribute comprises identifying, from the plurality of contracts, annotations that describe a structural context associated with the language pattern.

3. The method of claim 2, further comprising manually adding the annotations to the plurality of contracts.

4. The method of claim 2, wherein the annotations comprise extensible markup language tags.

5. The method of claim 1, wherein the contract attribute is specified in a component object model associated with the contract.

6. The method of claim 1, wherein determining at least one language pattern indicative of the contract attribute comprises generating a rule having a structural context component associated with the contract attribute and a regular expression associated with the language pattern.

7. The method of claim 6, wherein the regular expression is formed using a top-down induction method.

8. The method of claim 6, wherein the structural context component is specified in a document object model associated with the contract.

9. The method of claim 6, wherein determining whether the language pattern is present in the contract further comprises classifying a portion of the contract containing the language pattern into a subject category associated with the structural context component of the rule.

10. The method of claim 9, wherein classifying the portion of the contract comprises classifying into the subject category based on at least one language pattern in the portion indicative of the subject category.

11. A system, comprising:
a storage arrangement including a plurality of contracts stored in machine-readable form;
a learning arrangement coupled to the storage arrangement and configured to determine at least one language pattern indicative of a contract attribute from text of the plurality of contracts;
an extractor configured to determine whether the language pattern is present in a contract, the extractor further configured to, in response to the presence of the language pattern in the contract, assign a contract attribute to a portion of the text of the contract associated with the language pattern; and
a contracts facts database configured to store a data value conforming to the portion of the text assigned to the contract attribute.

12. The system of claim 11, wherein the learning arrangement is configured to determine at least one language pattern indicative of the contract attribute by identifying, from the plurality of contracts, annotations that describe a structural context associated with the language pattern.

13. The system of claim 12, wherein the learning arrangement is configured to accept a user input for manually adding annotations to the plurality of contracts.

14. The system of claim 12, wherein the annotations comprise extensible markup language tags.

15. The system of claim 11, wherein the learning arrangement is configured to determine at least one language pattern indicative of the contract attribute by generating a rule having a structural context component associated with the contract attribute and a regular expression associated with the language pattern.

16. The system of claim 15, wherein the rule is generated using a top-down induction method to form the regular expression.

17. The system of claim 11, wherein the contracts database comprises a relational database.

18. The system of claim 11, wherein the contracts database comprises an extensible markup language database.

19. A computer-readable medium configured with instructions for causing a processor of a data processing arrangement to perform steps comprising:
determining at least one language pattern indicative of a contract attribute from text from a plurality of contracts;
determining whether the language pattern is present in a contract; and
in response to the presence of the language pattern in the contract, assigning a portion of text associated with the language pattern to the contract attribute.

20. The computer-readable medium of claim 19, wherein determining at least one language pattern indicative of the contract attribute comprises identifying, from the plurality of contracts, annotations that describe a structural context associated with the language pattern.

21. The computer-readable medium of claim 20, wherein the steps further comprise manually adding the annotations to the plurality of contracts.

22. The computer-readable medium of claim 20, wherein the annotations comprise extensible markup language tags.

23. The computer-readable medium of claim 19, wherein determining at least one language pattern indicative of the contract attribute comprises generating a rule having a structural context component associated with the contract attribute and a regular expression associated with the language pattern.

24. The computer-readable medium of claim 23, wherein the rule is generated using a top-down induction method to form the regular expression.

25. A system comprising:
means for determining at least one language pattern indicative of a contract attribute from text from a plurality of contracts;
means for determining whether the language pattern is present in a contract; and
means for assigning text of the contract to a contract attribute in response to the presence of the language pattern in the contract.

26. The system of claim 25, further comprising means for identifying, from the plurality of contracts, annotations that describe a structural context associated with the language pattern.
